(19) United States
(12) Patent Application Publication
(10) Pub. No.: US 2014/0075299 A1
(43) Pub. Date: Mar. 13, 2014

(54) SYSTEMS AND METHODS FOR GENERATING EXTRACTION MODELS

(71) Applicants: Joshua Daniel Ain, Somerville, MA (US); Ryan Levering, Woburn, MA (US); Justin Andrew Boyan, Providence, RI (US)

(72) Inventors: Joshua Daniel Ain, Somerville, MA (US); Ryan Levering, Woburn, MA (US); Justin Andrew Boyan, Providence, RI (US)

(73) Assignee: GOOGLE INC., Mountain View, CA (US)

(21) Appl. No.: 13/615,029

(22) Filed: Sep. 13, 2012

(51) Int. Cl. G06F 17/20

(52) U.S. Cl. 715/255

(57) ABSTRACT

Disclosed systems and methods enable a user to train an extraction model by receiving a starting document and input from the user indicating tagged data from the starting document and creating an extraction model from the tagged data. Disclosed systems and methods also include identifying groups of additional documents based on a location of the starting document and displaying each of the groups to the user in order to receive a selection of at least one group from the user. Disclosed systems and methods also include applying the extraction model to the at least one group by evaluating the additional documents associated with the at least one group based on the extraction model to determine a confidence score for each of the additional documents, determining a document with a low confidence score, and displaying the particular document to the user to receive additional tagged data.

### TECHNICAL FIELD

This description relates to extracting data from data sources and, more specifically, to systems and methods for creating and training an extraction model to apply against a data source.

### BACKGROUND

The Internet provides a wealth of data. However, the information and data available through the Internet are only available in a format chosen by those who control the data. To provide the ability to collect, access, and analyze data which the analyzer does not control, tools have been developed to extract data from data sources not controlled by the analyzer. Specifically, structured data extractors, allow a user to acquire data from data sources, such as web pages, and to control the format of, analyze, and build upon the extracted data. Data extraction in such systems is accomplished through a machine-learning model called an extraction model.

In traditional structured data extractors, especially those that extract data from the Internet, a user teaches the extraction model what web pages should be included in the extraction set and what data on the pages should be extracted. This is often accomplished through an iterative training process where the data extraction system allows users to start on a page of interest, tag the data on the page, follow links to other pages of interest, tag data on the additional pages, and repeat the steps to teach the data extraction system how to find additional pages of interest and how to extract data from the additional pages. This can be a slow and laborious process for the user. Once the initial training is complete, the data extraction system runs the model on the extraction set of documents in the data source. But, if a user discovers errors in the extracted data after the initial training, the user generally adds new training examples, re-tags the new examples, and re-runs the extraction model on the entire extraction set again. If further errors are discovered this process is repeated. Thus the current methods for creating and training a data extraction model are time consuming, error prone, and unfriendly to novice users.

Therefore, a challenge remains to provide a user-friendly way of creating and training a data extraction model that reduces input from the user and speeds the training process.

### SUMMARY

One aspect of the disclosure can be embodied in a method that includes receiving a starting document from a user and receiving input from the user indicating tagged data from the starting document. The method may also include automatically identifying, by one or more processors, groups of additional documents based on a location of the starting document and generating data used to display each of the groups to the user. The method may include receiving from the user a selection of at least one group of the groups of additional documents, evaluating the additional documents associated with the at least one group based on the tagged data to determine a confidence score for each of the additional documents in the at least one group, and determining that a particular document has a low confidence score. The method may generate data used to display the particular document to the user and receive additional input from the user indicating additional tagged data in the particular document. The method may also include extracting, by the one or more processors, data from the additional documents associated with the at least one group based on the tagged data and the additional tagged data and generating data used to display the extracted data from the additional documents of the at least one group, wherein the displayed data is ordered by the confidence score for each additional document of the at least one group.

These and other aspects can include one or more of the following features. For example, the confidence score may be based on an unexpected document object model region, data in the particular document having outlier values, in comparison to other documents in the at least one group, tagged data that does not fit an expected format and/or structured fields that do not match an expected format. In some implementations the method includes repeating the evaluating, determining, generating, and receiving a predetermined number of times and/or until no documents have a confidence score below a threshold. In some implementations, identifying the groups of additional documents includes generating one or more regular expressions based on the location and identifying documents with locations matching the one or more regular expressions. In some implementations, the data used to display each of the groups may include a preview of at least one document in each group and an indication of an amount of documents in each group. In some implementations, the data used to display each of the groups of additional documents may also include a description of how each group was derived. In some implementations identifying a group of the groups of additional documents may include identifying a structure of the starting document and using the structure to identify similar documents.

In another example, some of the additional documents may be cached versions of web pages. In some implementations automatically identifying the groups of additional documents may include identifying a grouping of documents in the cached versions that includes the starting document and including the identified grouping of documents in the groups of additional documents. In some implementations, the method may further include determining a similarity score for each of a plurality of document groups for a domain, each document group for the domain representing pages matching a regular expression generated for the domain and identifying a group of the groups of additional documents may include identifying a set of the document groups having a regular expression that matches the location of the starting document and selecting the group having a highest similarity score from the set.

Another aspect of the disclosure can be a system for training an extraction model that includes at least one processor and a memory storing instructions that cause the at least one processor to perform operations. The operations may include receiving a starting document from a user, receiving input from the user indicating tagged data from the starting document, creating an extraction model, and identifying groups of additional documents based on a location of the starting document. The operations may also include generating data used to display each of the groups to the user, receiving from the user a selection of at least one group of the groups of additional documents, and applying the extraction model to the at least one group. Applying the extraction model may include evaluating the additional documents associated with the at least one group based on the extraction model to determine a confidence score for each of the additional documents, determining that a particular document has a low confidence score, and generating data used to display the particular document to the user for input, wherein the additional documents are ordered by confidence score.

In some implementations the operations may also include instructions that cause the at least one processor to repeat the evaluating, determining, generating, and receiving a predetermined number of times and or/until no documents have a confidence score below a threshold. In some implementations, as part of applying the extraction model, the instructions may also cause the one or more processors to perform the operation of receiving additional input from the user indicating additional tagged data in the particular document.

Another aspect of the disclosure can be a tangible computer-readable storage device having recorded and embodied thereon instructions that, when executed by at least one processor of a computer system, cause the computer system to receive a starting document from a user, receive input from the user indicating tagged data from the starting document, creating the extraction model, and automatically select a group of additional documents based on the extraction model. The instructions may also cause the computer system to apply the extraction model to the additional documents. Applying the extraction model may include evaluating the additional documents based on the extraction model to determine a confidence score for each of the additional documents and determining that a particular document has a low confidence score. Applying the extraction model may also include generating data used to display the particular document to the user for input indicating additional tagged data, and receiving the additional tagged data from the user. The instructions may cause the computer system to repeat the applying of the extraction model until no documents have a confidence score below a threshold and to generate data used to display information extracted from the additional documents through application of the extraction model, wherein the displayed data is ordered by the confidence score of each additional document. In some implementations, as part of selecting a group of additional documents, the instructions may further cause the computer system to identify the group based on a location of the starting document.

The details of one or more implementations are set forth in the accompanying drawings and the description below. Other features will be apparent from the description and drawings, and from the claims.

### BRIEF DESCRIPTION OF DRAWINGS

FIG. 1 illustrates an example system in accordance with the disclosed subject matter.

FIG. 2 is a flow diagram illustrating a process for creating and training an extraction model, consistent with disclosed implementations.

FIG. 3 is an example of a user interface for tagging a starting web page, consistent with disclosed implementations.

FIG. 4 is a flow diagram illustrating a process for suggesting groups of web pages to train the model, consistent with disclosed implementations.

FIG. 5 is an example of a user interface for receiving a selection of one or more groups of web pages, consistent with disclosed implementations.

FIG. 6 shows an example user interface for performing a final check on the extraction model, consistent with disclosed implementations.

FIG. 7 shows an example of a computer device that can be used to implement the described techniques.

Like reference symbols in the various drawings indicate like elements.

### DETAILED DESCRIPTION

Disclosed implementations enable users, especially novice users, to more easily create an extraction model, which includes choosing the extraction set and training the extraction model. For example, when extracting data from documents available on the Internet, some implementations eliminate the need for users to navigate to several documents to teach the model how to identify additional documents for the extraction set and to manually find and annotate outlier documents within the set. An extraction set may be a collection of documents that the user desires to extract information from. In some implementations, a data extraction system automatically selects potential documents for the extraction set rather than making the user teach the model which pages the user is interested in. In some implementations, the data extraction system may provide automatically selected documents to the user for selection.

In some implementations a data extraction system may allow a user to provide a document at a starting location, such as a web page located at a particular uniform resource locator (URL), and to tag the document before the system looks for additional pages. In such implementations the data extraction system may use the tags to determine similar documents. Similar pages may be identified based on a confidence score, which may be an indication of how confident the machine-learning extraction model is that a particular page fits the model. In some implementations the system may use the confidence score for individual documents to automatically select a collection of documents for use as the extraction set. As part of training the extraction model, the user may indicate that certain documents are not applicable and the system may use this knowledge to exclude other documents from the extraction set.

In some implementations the system may provide the user with an interface that presents one or more groups of documents automatically selected by the data extraction system and allow the user to select those groups to be included in the extraction set. In such implementations, the system may show a preview of the suggested documents to the user, a number of pages in the group, and the logic used to select the documents of the group. In such implementations the data extraction system may also provide the user with an opportunity to remove certain documents from the group or to explicitly provide additional documents for inclusion.

Disclosed implementations may also provide a faster and more efficient training process for the extraction model. For example, after the user provides annotations for the starting document, the data extraction system may create an extraction model based on the annotations and apply the model to the documents in a training set of the extraction set. The training set may be a subset of the extraction set, or can be the full extraction set. In some implementations, the training set may be documents from the extraction set that are newer than a specified time frame.

After applying the model, the data extraction system may identify documents deemed suspicious because of errors encountered when attempting to apply the model. Having identified suspicious pages, the data extraction system may present one of the suspicious documents to the user for further training through annotation. Accordingly, the data extraction system may allow the user to correct tags, supply additional tags for the document, or indicate that the document should not be included in the extraction set. The data extraction system may then update the extraction model with the user-supplied corrections and run the model against the training set, allowing the system to properly extract data from similar documents. For example, if the user indicates that the date field is in a different location for a particular document, the system may learn from this and be able to correctly locate the date field on other similarly structured documents. In another example, if the user indicates that the document should not be included in the collection, the system may remove any similar documents from the collection.

In some implementations, the system may present a predetermined number of documents for annotation. In such implementations, the documents presented may not actually contain errors, but displaying a predetermined number of documents for annotation may give the user a level of confidence that the extraction model is working correctly and sufficiently trained. In some implementations the data extraction system may present suspicious documents to the user until no suspicious documents remain. In some implementations the data extraction system may determine training is complete when no documents meet a suspiciousness threshold and the data extraction system has displayed at least a predetermined number of documents for annotation.

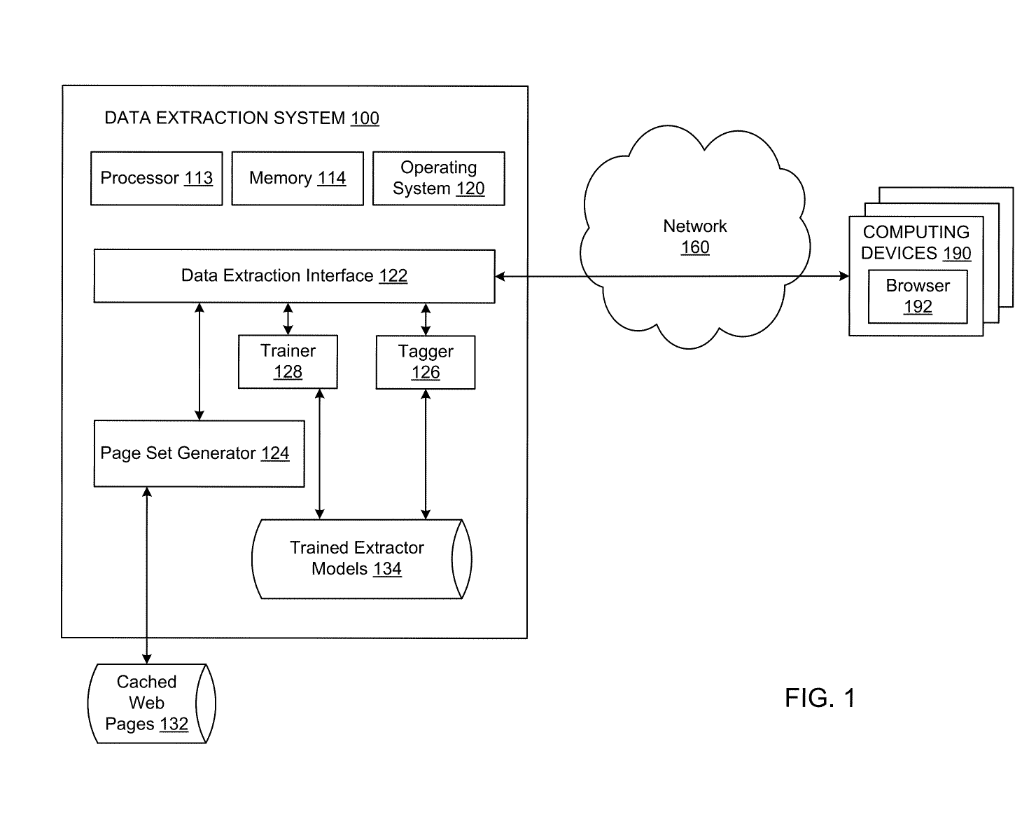

FIG. 1 is a block diagram of a data extraction system 100 in accordance with an example implementation. The data extraction system 100 may be used to implement the data extraction techniques described herein. The depiction of data extraction system 100 in FIG. 1 is described as a system for extracting data from web pages available over the Internet, but it will be appreciated that the data extraction techniques described may be used to extract data from other data sources, such as databases, spreadsheets, internal document repositories, web service feeds, etc. Accordingly, pages, as used herein, may refer more generally to any text-based documents, such as source code files, web pages, spreadsheets, word-processing files, PDF documents, text files, XML files, etc.

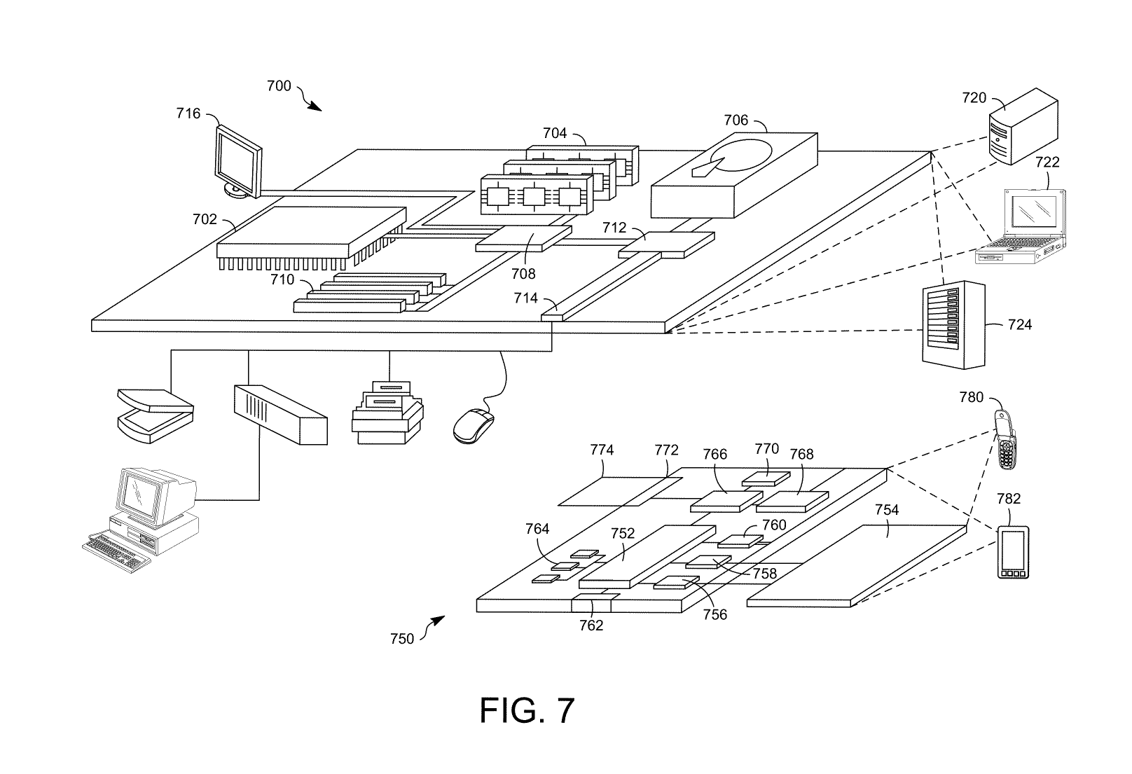

The data extraction system 100 may be a computing device that takes the form of a number of different devices, for example, a standard server, a group of such servers, or a rack server system. In some implementations, data extraction system 100 may be implemented in a personal computer, or a laptop computer. The computing device of data extraction system 100 may be an example of computer device 700, as depicted in FIG. 7.

Data extraction system 100 can include one or more processors 113 configured to execute one or more machine executable instructions or pieces of software, firmware, or a combination thereof. The data extraction system 100 can include an operating system 122 and one or more computer memories 114, for example a main memory, configured to store data, either temporarily, permanently, semi-permanently, or a combination thereof. The memory 114 may include any type of storage device that stores information in a format that can be read and/or executed by processor 113. Memory 114 may include volatile memory, non-volatile memory, or a combination thereof. In some implementations, memory 114 may store modules, for example modules 120-128. In some implementations one or more of the modules may be stored in an external storage device (not shown) and loaded into memory 114. The modules, when executed by processor 113, may cause data extraction system 100 to perform certain operations.

For example, in addition to operating system 122, the modules may also include a data extraction interface 122, a page set generator 124, a trainer 128, and a tagger 126. Data extraction interface 122 may allow a user of computing device 190 to interact with and receive data from data extraction system 100. For example, data extraction interface 122 may generate data used to receive a starting web page from the user, to display the web page to the user, to display groups of web pages to a user for selection, to receive tagged data and group selections from the user, etc. Data extraction interface 122 may work with page set generator 124, trainer 128, and tagger 126 to provide this functionality. Tagger 126 may provide operations that allow a user to tag data in a web page. Tagging data may include identifying the data on the web page and associating a label and, optionally, a format with the data. For example, U.S. Patent Publication No. 2010/1045902 entitled “Methods and Systems to Train Models to Extract and Integrate Information From Data Sources,” incorporated herein by reference, provides one example of tagging data in a web page, although implementations may include other methods of tagging.

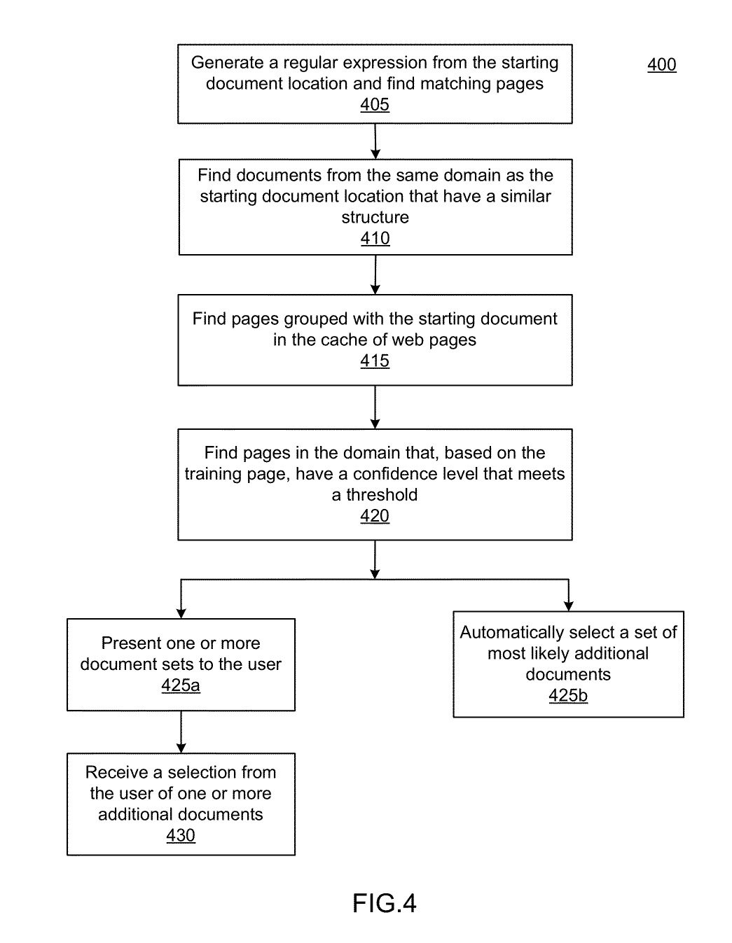

Page set generator 124 may automatically generate groups of web pages as potential extraction pages in an extraction set. An extraction set may represent the set of documents from a data source that the user desires to extract data from. For example, page set generator 124 may apply a number of algorithms to the location, e.g. the URL, of a starting web page to generate one or more groups of web pages. Example algorithms are described in more detail below with regard to FIG. 4. Page set generator 124 may work with data extraction interface 122 to provide the groups to the user for selection, allowing the user to select one or more of the groups. Trainer 128 may use all or a portion of the documents in the selected groups to train the extraction model. The portion of documents used may be considered a training set. For example, trainer 128 may apply tagged data from a starting web page to the pages of the selected groups and identify pages within the group that the trainer 128 considers suspicious. A suspicious page may be a page that produces one or more errors when run against the extraction model. In some implementations the trainer 128 may present suspicious pages to the user for correction and training until no suspicious pages remain in the training set of web pages.

Data extraction system 100 may include a data source, for example cached web pages 132. In one example, cached web pages 132 may be part of an index for an Internet search engine. The data source, such as cached web pages 132, may be stored externally to data extraction system 100 or may be stored as part of data extraction system 100. Pages stored in cached web pages 132 may be associated with attributes, such as a URL, a last updated date, etc. Although FIG. 1 shows cached web pages 132 as the data source, it will be apparent that other data sources, such as databases, spreadsheets, internal document repositories, etc., may be included in the data source extraction system 100. Cached web pages 132 may be a subset of the web pages available via the Internet and need not be a complete set.

Data extraction system 100 may also include trained extractor models 134. Trained extractor models 134 may include models based on a start page and user-identified tags for the start page. As the trainer 128 applies the model to pages from a group of extraction pages selected by page set generator 124, the user may tag additional data on pages from the group, may remove pages from the extraction pages, or add additional pages to the extraction pages. All of these user actions may cause trainer 128 and/or tagger 126 to update the model, storing the updates in trained extractor models 134.

A user creating and training an extraction model may use computing devices 190, which may be any type of computing device in communication with data extraction system 100, for example, over network 160. Computing devices 190 may include desktops, laptops, netbooks, tablet computers, mobile phones, smart phones, televisions with one or more processors, etc. For example, computing devices 190 may be an example of computing device 750 of FIG. 7. In some implementations, computing device 190 may be part of data extraction system 100 rather than a separate computing device. In some implementations, computing device 190 may include a web browser 192 that allows the user to communicate with data extraction system 100.

Data extraction system 100 may be in communication with the computing devices 190 over network 160. Network 160 may be for example, the Internet or the network 160 can be a wired or wireless local area network (LAN), wide area network (WAN), etc., implemented using, for example, gateway devices, bridges, switches, etc. Via the network 160, the data extraction system 100 may communicate with and transmit data from computing devices 190. As mentioned above, in some implementations computing devices 190 may be incorporated into and part of data extraction system 100, making network 160 unnecessary.

Although FIG. 1 nominally illustrates a single computing device executing the data extraction system, it may be appreciated from FIG. 1 and from the above description that, in fact, a plurality of computing devices, e.g., a distributed computing system, may be utilized to implement the data extraction system. For example, any of components 120-128 may be executed in a first part of such a distributed computing system, while any other of components 120-128 may be executed elsewhere within the distributed system.

More generally, it may be appreciated that any single illustrated component in FIG. 1 may be implemented using two or more subcomponents to provide the same or similar functionality. Conversely, any two or more components illustrated in FIG. 1 may be combined to provide a single component which provides the same or similar functionality. In particular, as referenced above, the cached web pages 132 and the trained extractor models 134, although illustrated as stored using data extraction system 100, may in fact be stored separately from the data extraction system 100. Thus, FIG. 1 is illustrated and described with respect to example features and terminologies, which should be understood to be provided merely for the sake of example, and not as being at all limiting of various potential implementations of FIG. 1 which are not explicitly described herein.

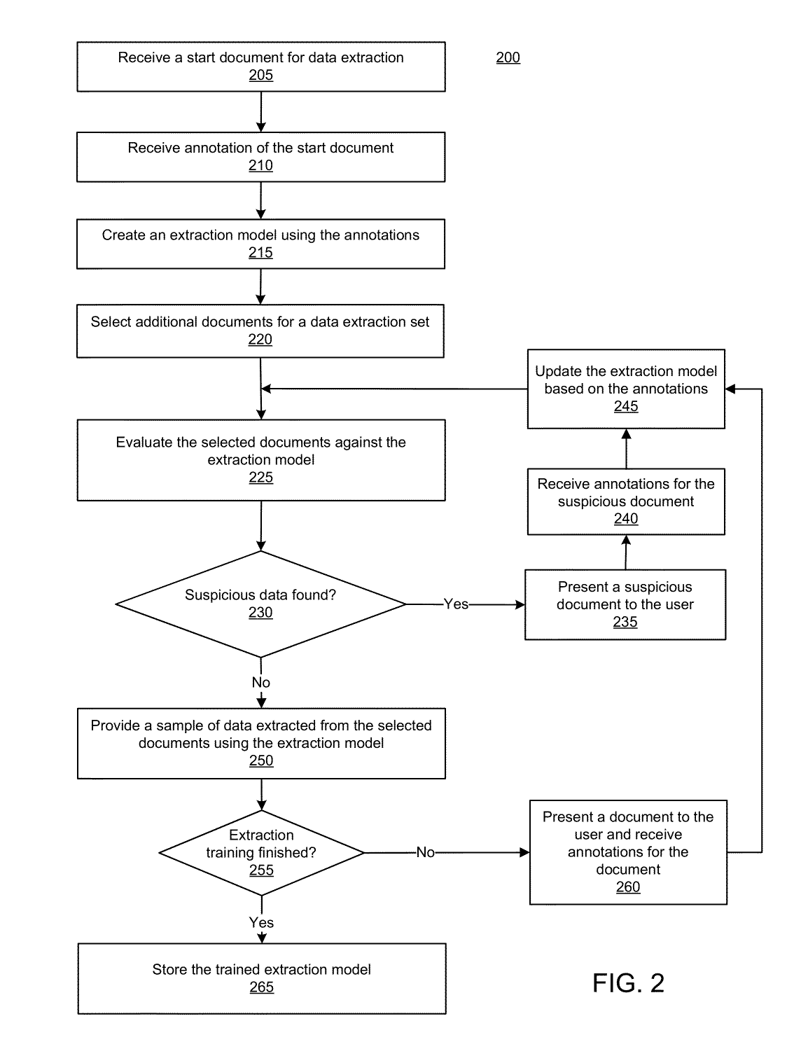

FIG. 2 is a flow diagram illustrating a process 200 for creating and training an extraction model, consistent with disclosed implementations. A data extraction system, such as data extraction system 100 shown in FIG. 1, may use process 200 to receive extraction model training criteria from a user and to lead the user through the training process. For example, a page set generator, such as page set generator 124 of FIG. 1, may assist the user in selecting pages to be included in an extraction set and a trainer, such as trainer 128 of FIG. 1, may assist the user in training the extraction model against some or all of the pages in the extraction set.

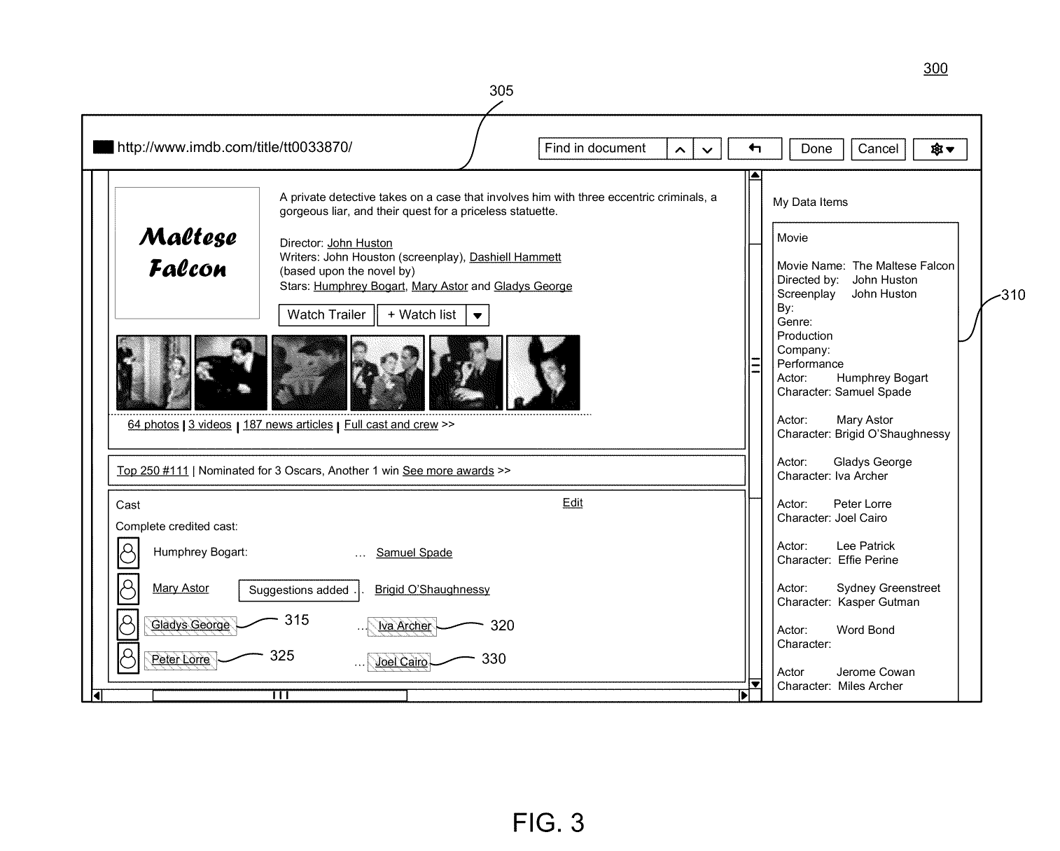

At step 205, the data extraction system 100 may receive a starting document for data extraction. Data extraction system 100 may use the starting document as the basis for an extraction model. In some implementations the starting document may be a web page located at a particular URL, although it could be a selection of cells in a spreadsheet, a document from a document repository, etc. After receiving the starting document, the data extraction system 100 may display a fully rendered version of the page and receive annotations for the starting document (step 210). For example, data extraction system 100 may present a user interface, such as the user interface of FIG. 3 to the user that shows a fully rendered version of the page 305 and an area that depicts tagged data 310.

The user interface of FIG. 3 enables the user to select data items shown in page 305 and to assign the selected data items a tag. For example, user interface 300 may allow a user to select data items by highlighting the data. After selecting a data item, the user interface 300 may allow a user to select a tag from a pop-up menu of available tags or to type a tag name in a text box. Selected data items and their associated tags may collectively be considered tagged data 310. For example, in FIG. 3 tagged data 310 includes the tag of “movie name” and “actor,” among others. The data associated with the “actor” tag in FIG. 3 includes “Humphrey Bogart” and “Mary Astor” among others. In addition to receiving tagged data 310, the data extraction system 100 may also suggest tagged data to the user. For example, the data extraction system 100 may detect that the user has applied a consistent pattern of two or more tags to the same data type and automatically suggest additional tagged data to complete the pattern. For example, items 315-330 of FIG. 3 represent suggested tagged data, which the user can accept, reject, or correct. This process of receiving tagged data from the user may constitute annotating the starting document.

Returning to FIG. 2, data extraction system 100 may create an extraction model using the annotations (step 215). For example, the data extraction system 100 may store the data fields identified by the user and the tags associated with the data fields as part of the extraction model. In some implementations the extraction model may also include the location of the starting document and information for identifying documents in the extraction set. Some implementations may also include information for selecting a training set from the extraction set.

At step 220 data extraction system 100 may select additional documents for a data extraction set. In some implementations, data extraction system 100 may automatically select the additional documents for the data extraction set from a cache of documents, such as cached web pages 132 shown in FIG. 1. Using a cache of documents enables the data extraction system 100 to train the model and find pages for the model without having to individually fetch pages from the original data source. For example, data extraction system 100 may have access to a search index of documents in the data source, such as a search index for web pages. In some implementations, the data extraction system 100 may use only pages in the cache that are newer than a specified date, such as 5 days old or less, for training the model. In some implementations the data extraction system 100 may identify groups of additional documents from the cache and present the groups to the user for selection.

FIG. 4 is a flow diagram illustrating a process 400 for selecting additional documents for a data extraction set, consistent with disclosed implementations. The process 400 may apply one or more page set generating algorithms to the location of the starting document to produce one or more groups of pages. For instance, at step 405 the data extraction system 100 may generate a regular expression from a starting document location and find pages at locations that match the regular expression. For example, given the URL http://www.imdb.com/title/tt123456/ for the starting document, the data extraction system 100 may generate the following regular expressions: http://www.imdb.com/title/tt*/; http://www.imdb.com/title/*/; and http://www.imdb.com/*/*/. In some implementations the regular expressions may be generated by walking back the URL to the domain, e.g., www.imdb.com, and providing a broader set of documents from the domain. In some implementations the regular expressions may be generated by substituting various portions of the URL path with a wildcard, such as http://*.imdb.com/*/*123456/ or http://*.imdb.*/title/*. Some implementations may include a union of similar regular expressions into a group of pages. For example, the data extraction system 100 may group the regular expressions http://www.imdb.com/*/tt*/ and http://www.imdb.com/*/sm*/ together based on a similarity of underlying page types. Other regular expression operators, such as # and ? may be used to generate a regular expression from the URL. In some implementations the data extraction system 100 may also determine how many pages are associated with the locations represented by the regular expressions. For example, data extraction system 100 may apply the regular expression to a cache of web pages used by a search engine and count the number of pages that match the location(s) represented by the regular expression.

In some implementations the data extraction system 100 may have previously calculated a similarity score for groups of pages in a domain represented by a regular expression. For example, using the www.imdb.com example above, the data extraction system 100 may use cached pages to generate groups for imdb.com based on regular expressions such as those indicated above. The pre-calculated similarity score may represent the similarity of the pages contained within the group, such as http://www.imdb.com/* or http://www.imdb.com/title/*. In such an implementation, a group with highly similar pages may have a higher score than a group with varied pages. The data extraction system 100 may use the pre-calculated similarity score to select a group represented by the regular expression that best matches the tagged data from the start page. For example, the data extraction system may determine what groups the starting page belongs to, for example because its URL matches the regular expression used to generate the group, and may choose a group or groups having the highest similarity scores. In some implementations, when groups have a similar similarity score, the data extraction system 100 may choose the group that has the highest number of members and a highest similarity score.

At step 410, in addition to or instead of generating a regular expression, the data extraction system 100 may locate documents from the domain of the starting document that have a similar structure as the starting document. For example, if the starting document is a web page, the data extraction system 100 may look for web pages that have a similar HTML structure or document object model (DOM) structure. In some implementations, the data extraction system 100 may use the tagged data from the starting page to determine what portion of the page the user considers important. In such implementations the data extraction system 100 may look for pages in the domain that have a similar HTML structure or DOM structure in the user-identified important portion of the page. In some implementations, data extraction system 100 may locate documents from the domain of the starting document that have similar key header elements. Similar key header elements may include similar titles, similar table headers, similar list headers, or some other indication that the web pages come from the same template. Data extraction system 100 may use a combination of the methods described above to identify pages with a similar structure. As with the regular expression algorithm, in some implementations the data extraction system 100 may determine the number of pages that have a similar structure or an important part of the page with similar structure.

At step 415, in addition to or instead of the two page-set generating algorithms described above, the data extraction system 100 may locate pages grouped with the starting document in the cache of web pages. For example, data extraction system 100 may have access to a search index for documents in the data source, such as an index of pages available via the Internet. The search index may have grouped pages together based on similar HTML structure, use of boilerplate HTML, or for some other similarity. Data extraction system 100 may take advantage of this grouping by the search index and offer the already grouped pages as a potential set of pages to the user.

At step 420, in addition to or instead of the three page-set generating algorithms described in steps 405-415, the data extraction system 100 may locate pages in the same domain as the starting page, apply the tagged data to the pages in the same domain, and calculate a confidence score for each page based on how well the page matches the pattern of the starting page, as explained in more detail below with regard to step 225 of FIG. 2.

In some implementations, the data extraction system 100 may keep only those pages that have a confidence score that meets a predetermined threshold (step 425b). In such an implementation the data extraction system 100 may automatically select the additional pages for the user. Thus, the user need only provide annotations for the starting document and the data extraction system 100 may automatically choose pages for the extraction set. In such implementations, the data extraction system 100 may store an indication of the extraction set as part of the extraction model.

In some implementations, the data extraction system 100 may present one or more groups of documents located using one or more of the algorithms described above with regard to steps 405 to 420 to the user for selection (step 425a). In some implementations, the data extraction system 100 may order the groups presented by a confidence score for the groups. In such implementations, the data extraction system 100 may present the groups with a higher confidence score to the user in a position of preference with respect to the other groups. In some implementations some other calculation may be applied to the documents in each group to determine the most promising groups, such as the number of documents associated with each group. The user may then be allowed to select one or more of the groups of additional documents (step 430). In some implementations, the user may also be able to provide information, such as a regular expression, that data extraction system 100 can use to identify pages for the extraction set.

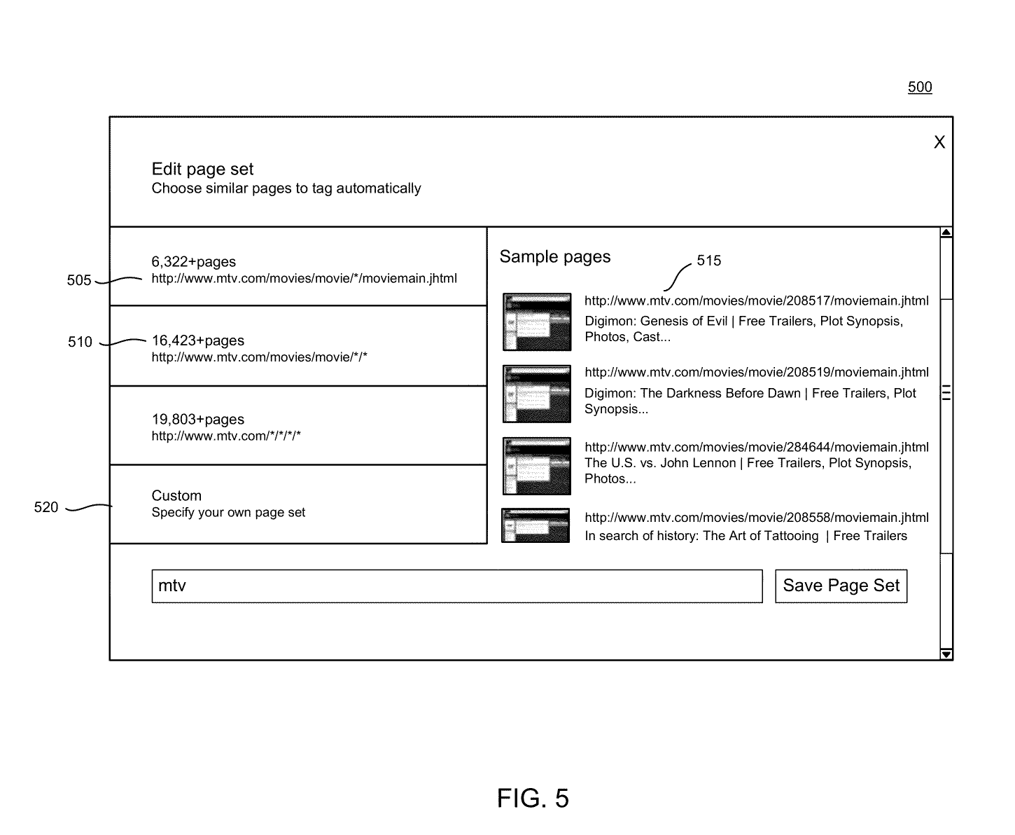

FIG. 5 is an example user interface 500 for receiving a selection of one or more groups of web pages, consistent with disclosed implementations. Data extraction system 100 may use interface 500 as part of steps 425a and 430 of FIG. 4. User interface 500 may include an indication of a description 505 of how the group was derived. For example, the description 505 may indicate the regular expression used to locate the pages or a summary of the HTML structure used to locate the pages. User interface 500 may also include an indication of the number of pages in the group 510. In some implementations, user interface 500 may also contain a sample page 515 from the group. The sample page may be chosen at random, or may be chosen based on a confidence score, as described above. Some implementations may also include a control or field 520 that allows the user to specify a page set. After a user selects the pages to be included in the extraction set, the user may save the set. In some implementations the extraction set is saved as part of the extraction model.

Returning now to FIG. 2, it will be apparent that annotating the starting page (step 210) need not be performed before applying the set generating algorithms to select additional documents for the data extraction set (step 220). In some implementations the annotating may be performed after the selection of the additional documents using, for example, process 400.

At step 225 the data extraction system 100 may evaluate the documents in the extraction set. To evaluate the documents, the data extraction system 100 may apply the extraction model, which is based on the tagged data, to each page in the extraction set and calculate a confidence score for each page. In some implementations, the extraction set may be cached web pages used by a search engine. In some implementations, the data extraction system 100 may limit the pages to which the tagged data is applied to pages that are newer than a specified number. For example, to train the extraction model, the data extraction system 100 may only use pages that are newer than 5 days. A confidence score for each page may be based on how well the page matches the pattern established by the extraction model using the tagged data.

Several factors may affect the confidence score. These include structured fields that do not parse well, such as dates, addresses, prices, etc. Such fields may have a format in the starting page that does not match the format in another page of the extraction set. For example, the data extraction system 100 may encounter an unknown date format or an address field lacking a street address. Such parsing errors may lower the confidence score for a particular page. In addition, fields with unusual outlier values may lower the confidence score. For example, a field that is usually 30 characters long in other pages may only have one or two characters in the current page. This event may cause the data extraction system 100 to lower the confidence score for the current page. Fields with an unusual or a different HTML or document object model (DOM) region, when compared with the other pages in the set, may also lower the confidence score. For example, the data extraction model may find a phone number, but in a location that was unexpected. The confidence score may also reflect the machine learning algorithm's confidence that the extraction model matched the information on the page. In other words, the data extraction system 100 may base the confidence score on how well it could apply the extraction model to the page. Data extraction system 100 may use these errors and others to calculate a confidence score for each page in the selected set of documents.

In some implementations, data extraction system 100 may compare the confidence scores for each page with a threshold. If the confidence score meets the threshold, then the data extraction system 100 may determine that suspicious data was found (step 230). For example, if a confidence score for a particular page is below the threshold, the page may be considered as having suspicious data. In some implementations, data extraction system 100 may determine suspiciousness using a combination of the threshold and a minimum repetition. For example, data extraction system 100 may determine that suspicious data exists if a counter has not yet reached a predetermined number or if a confidence score of one of the pages in the extraction set meets, for example is below, the threshold. In such systems, the counter may be incremented each time the documents are evaluated against the extraction model (step 225), thus ensuring that the user is presented with at least a minimum number of pages from the extraction set.

When suspicious data is found (step 230, Yes), the data extraction system 100 may determine pages with low confidence scores. These pages may be considered the most suspicious documents. Of course, in some implementations pages with a high confidence score may be considered suspicious, if a high number indicates a low confidence. Data extraction system 100 may present one of the pages considered suspicious to the user (step 235). For example, data extraction system 100 may choose a page with a low confidence score. Data extraction system 100 may then allow the user to annotate the page (step 240). This allows the user to teach the data extraction system 100 how to tag the suspicious page. In some implementations, as part of annotating the page the user may indicate that the suspicious page should not be included in the extraction set. Based on the annotations from the user, the data extraction system may update the model (step 245) and re-evaluate the selected documents using the updated extraction model (step 225). Thus, at 225 the pages may be re-evaluated using the newly updated extraction model and a confidence score for each page re-calculated and compared against the predetermined threshold.

As indicated above, in some implementations the data extraction system 100 may repeat the training loop created by steps 235 to 225 for a predetermined number of documents. For example, the data extraction system 100 may repeat the training loop for a minimum of five documents. In this example, if upon the second iteration of evaluation of the pages (step 225), no pages have a confidence score that meets the threshold, the data extraction system 100 may still consider suspicious pages found (230, Yes) because the iteration counter, which is currently two, has not reached the minimum number of iterations. Thus, the data extraction system 100 may pick a page with a low confidence score as suspicious, even if this confidence score does not meet the threshold, and display this page in step 235. Such repetition even if a page does not meet the threshold enables the user to have confidence that the model will work correctly when applied to the full extraction set. Similarly, in some implementations if the number of repetitions is met but a page remains with a confidence level that meets the threshold, the system may reset the iteration counter. This may cause the data extraction system to repeat the training loop another minimum number of times.

When no suspicious data is found (step 230, No), the data extraction system 100 may provide the user with a sample of data extracted from the documents of the extraction set using the extraction model (step 250) to allow the user to perform a final check on the extraction model. In some implementations the data extraction system 100 may present extracted data with unusual results at the top of the sample, so the user can see the most unusual results first. Unusual results may be determined based on any of the factors used in calculating the confidence score. In some implementations the data presented in the final check may be from random pages. If, after viewing the sample data, a user indicates that the training is not finished (step 255, No) the data extraction system 100 may present the page that corresponds to the extracted data that the user was viewing and allow the user to annotate the page (step 260). In some implementations, data extraction system 100 may then re-enter the training loop at step 245. In some implementations, data extraction system 100 may re-set the counter so that the training loop occurs a minimum number of times. In other implementations the data extraction system 100 may perform step 250 after receiving annotations for the document, rather than entering the training loop. If the user indicates that training is finished (step 255, Yes), then the data extraction system 100 may store the trained extraction model (step 265). In some implementations, the stored extraction model may then be run against live, or not cached, versions of the pages.

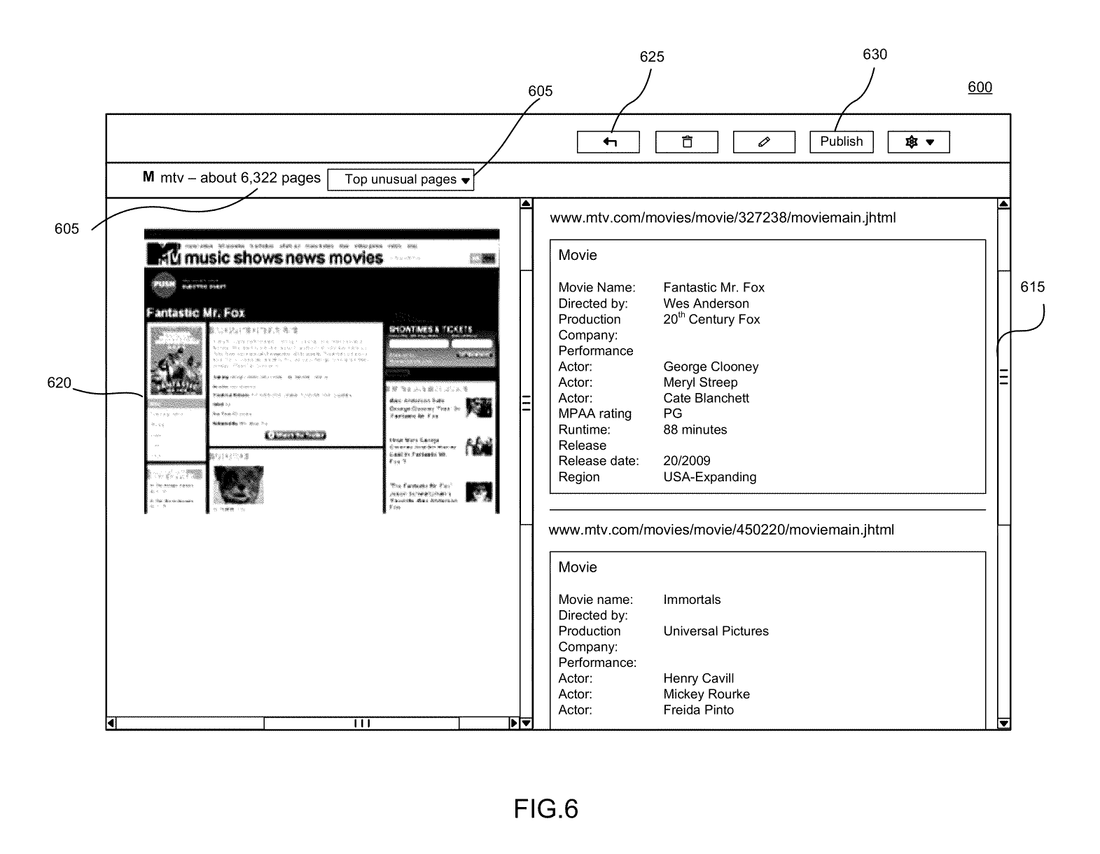

FIG. 6 is an example user interface 600 for performing a final check on the extraction model, consistent with disclosed implementations. User interface 600 may allow a user to view the data extracted from a sample of the pages in the extraction set. In some implementations the user interface 600 may provide the user with a control 605 that allows the user to see the top unusual pages. As described above with regard to step 250 above, the top unusual pages may be determined based on the confidence of the model in the extraction. In some implementations, the control 605 may allow the user to see random pages selected from the extraction set. User interface 600 may also include an indication 610 of the number of pages in the extraction set. User interface 600 may provide a list 615 of the data extracted from the sample pages. A user may scroll through the sample pages to browse the data extracted using the extraction model. In some implementations, user interface 600 may also provide a preview 620 of the document associated with extracted data currently selected in list 620. By default, the first set of data in the list may be selected. A user may select a different set of data in list 615 by, for example, clicking on the data.

In some implementations the user interface 600 may provide the user with an opportunity to re-enter the training loop through control 625 or to finalize the extraction model through control 630. When re-entering the training loop, the data extraction system 100 may give the user may the ability to annotate the currently selected web page. In some implementations, when the user indicates the extraction model is final, for example by selecting control 630, the extraction model is saved and indicated as final. In implementations that use cached web pages from a search index, a search engine associated with the search index, e.g., cached web pages 132, may add pages to the extraction set as the search engine encounters newly added pages that match the extraction model.

The process shown in FIGS. 2 and 4 are examples of one implementation, and may have steps deleted, reordered, or modified. For example, step 220 may be performed before step 210 and steps 210 and 215 may be combined, and any of steps 405 to 420 may be deleted. Thus a user may enter a start URL and the data extraction system 100 may generate proposed extraction sets for the user to choose from before annotating the starting URL. Alternatively, the user may annotate the first page before the data extraction system 100 generates the URL. Furthermore, the data extraction system 100 may automatically choose an extraction set or may allow the user to choose the set.

FIG. 7 shows an example of a generic computer device 700 and a generic mobile computer device 750, which may be used with the techniques described here. Computing device 700 is intended to represent various forms of digital computers, e.g., laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be examples only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, for example, display 716 coupled to high speed interface 708. In some implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, for example, a magnetic or optical disk.

The storage device 706 is capable of providing mass storage for the computing device 700. In one implementation, the storage device 706 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, for example, the memory 704, the storage device 706, or memory on processor 702.

The high speed controller 708 manages bandwidth-intensive operations for the computing device 700, while the low speed controller 712 manages lower bandwidth-intensive operations. Such allocation of functions is an example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, for example, a keyboard, a pointing device, a scanner, or a networking device, for example a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer like laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” and “computer-readable storage device” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving a starting document from a user;
receiving input from the user indicating tagged data from the starting document;
automatically identifying, by at least one processor, groups of additional documents based on a location of the starting document;
generating, by the at least one processor, data used to display each of the groups to the user;
receiving from the user a selection of at least one group of the groups of additional documents;
evaluating the additional documents associated with the at least one group based on the tagged data to determine a confidence score for each of the additional documents in the at least one group;
determining that a particular document has a low confidence score;
generating data used to display the particular document to the user;
receiving additional input from the user indicating additional tagged data in the particular document;
extracting, by the at least one processor, data from the additional documents associated with the at least one group based on the tagged data and the additional tagged data; and
generating data used to display the extracted data from the additional documents of the at least one group, wherein the displayed data is ordered by the confidence score for each additional document of the at least one group.

2. The method of claim 1, wherein the method further includes repeating the evaluating, determining, generating, and receiving a predetermined number of times.

3. The method of claim 1, wherein the method further includes repeating the evaluating, determining, generating, and receiving until no documents have a confidence score below a threshold.

4. The method of claim 1, wherein the confidence score is based on an unexpected document object model region.

5. The method of claim 1, wherein the confidence score is based on data in the particular document having outlier values, in comparison to other documents in the at least one group.

6. The method of claim 1, wherein the confidence score is based on tagged data that does not fit an expected format.

7. The method of claim 1, wherein the confidence score is based on structured fields that do not match an expected format.

8. The method of claim 1, wherein identifying the groups of additional documents includes:
generating one or more regular expressions based on the location; and
identifying documents with locations matching the one or more regular expressions.

9. The method of claim 1, wherein at least some of the additional documents are cached versions of web pages.

10. The method of claim 9, wherein automatically identifying the groups of additional documents includes:
identifying a grouping of documents in the cached versions that includes the starting document; and
including the identified grouping of documents in the groups of additional documents.

11. The method of claim 9, further comprising:
determining a similarity score for each of a plurality of document groups for a domain, each document group for the domain representing pages matching a regular expression generated for the domain,
wherein identifying a group of the groups of additional documents includes:
identifying a set of the document groups having a regular expression that matches the location of the starting document, and
selecting the group having a highest similarity score from the set.

12. The method of claim 1, wherein the data used to display each of the groups includes:
a preview of at least one document in each group; and
an indication of an amount of documents in each group.

13. The method of claim 12, wherein the data used to display each of the groups of additional documents further includes a description of how each group was derived.

14. The method of claim 1, wherein identifying a group of the groups of additional documents includes:
identifying a structure of the starting document; and
using the structure to identify similar documents.

15. A system comprising:
at least one processor; and
a memory storing instructions that, when executed by the at least one processor, cause the system to perform operations comprising:
receiving a starting document from a user,
receiving input from the user indicating tagged data from the starting document, creating an extraction model,
identifying groups of additional documents based on a location of the starting document,
generating data used to display each of the groups to the user,
receiving from the user a selection of at least one group of the groups of additional documents,
applying the extraction model to the at least one group by:
evaluating the additional documents associated with the at least one group based on the extraction model to determine a confidence score for each of the additional documents,
determining that a particular document has a low confidence score, and
generating data used to display the particular document to the user for input, wherein the additional documents are ordered by confidence score.

16. The system of claim 15, wherein as part of applying the extraction model the instructions further cause the at least one processor to perform operations comprising:
receiving additional input from the user indicating additional tagged data in the particular document.

17. The system of claim 16, wherein the instructions further cause the at least one processor to repeat the evaluating, determining, generating, and receiving a predetermined number of times.

18. The system of claim 16, wherein the instructions further cause the at least one processor to repeat the evaluating, determining, generating, and receiving until no documents have a confidence score below a threshold.

19. A computer-readable storage device for generating and training an extraction model, the storage device having recorded and embodied thereon instructions that, when executed by at least one processor of a computer system, cause the computer system to:
receive a starting document from a user;
receive input from the user indicating tagged data from the starting document, creating the extraction model;
automatically select a group of additional documents based on the extraction model;
apply the extraction model to the additional documents by:
evaluating the additional documents based on the extraction model to determine a confidence score for each of the additional documents,
determining that a particular document has a low confidence score,
generating data used to display the particular document to the user for input indicating additional tagged data, and
receiving the additional tagged data from the user;
repeat the applying of the extraction model until no documents have a confidence score below a threshold; and
generate data used to display information extracted from the additional documents through application of the extraction model, wherein the displayed data is ordered by the confidence score of each additional document.

20. The storage device of claim 19, wherein the instructions further cause the computer system to perform the repeating a predetermined number of times, regardless of the confidence score.

21. The storage device of claim 19, wherein as part of selecting a group of additional documents, the instructions further cause the computer system to:
identify the group based on a location of the starting document.
